(19) United States
(12) Patent Application Publication
(10) Pub. No.: US 2014/0279648 A1
(43) Pub. Date: Sep. 18, 2014

(54) SYSTEMS, DEVICES, AND METHODS FOR THE USE OF A MOBILE DEVICE TO GENERATE A SHIPPING LABEL

(71) Applicant: Patrick Whitehouse, Redwood City, CA (US)

(72) Inventor: Patrick Whitehouse, Redwood City, CA (US)

(21) Appl. No.: 13/843,483

(22) Filed: Mar. 15, 2013

(51) Int. Cl. G06Q 10/08

(52) U.S. Cl. CPC G06Q 10/083
USPC 705/330

(57) ABSTRACT

Systems, devices, and methods are provided for a sender to use of a mobile device to interface with a shipping agent's environment for the purpose of generating a shipping label. The sender can identify shipping label information through a software application operating on the sender's mobile device. The application can facilitate the transfer of the shipping label information to the shipping agent's environment, such as a kiosk or a retail counter, and the like. The shipping agent's environment can then produce or print a hardcopy of the shipping label for use on the mail piece (e.g., parcel or package) to be shipped.

### FIELD

The subject matter described herein relates to systems, devices, and methods for transferring shipping data, such as shipping label information and other information about the shipment, from a mobile device to an entity capable of the creation of a shipping label.

### BACKGROUND

Professional package shippers have software tools which enable them to prepare information-rich shipping labels quickly and easily. An example of such a shipping label is shown in FIG. 1. Carriers make these software tools available for free or at a nominal charge. Most professional shippers have standing accounts with the carriers and thus are considered as “known shippers.” Typically, known shippers have a long history of shipping with a certain carrier and are organized in such a way that makes it difficult to introduce a dangerous package or parcel into the shipping stream.

The casual shipper is a much different situation and a cause for concern amongst the carriers. This might be a business person on travel wishing to ship materials back to her office, a family on vacation wishing to ship gifts back to the relatives at home, or a grandmother shipping a birthday gift to her grandson. Conversely, the casual shipper could be an individual attempting to send a dangerous package (e.g., an explosive, a hazardous biological material, etc.) to commit an act of terrorism.

While each carrier implements security measures differently, the goal of eliminating dangerous packages remains the same. In this regard, the security protocols of the US Postal Service (“USPS”) are exemplary.

Interestingly, the US Postal Inspection Service (“USPIS”) relies heavily on the expertise and memory of the USPS retail clerks. They are trained to look for telltale indications of dangerous packages such as suspicious behavior, leaks or stains on a package being inducted, and the use of anonymous postage, like standard postage stamps. These same guidelines apply to the handling of a package in back-room operations.

As another security measure, packages bearing anonymous stamps and over 13 ounces cannot be placed in a USPS collection box. This message is invariably conveyed on postal deposit “blue-boxes” across the United States. Current USPS rules require stamp-bearing packages to be presented to a USPS retail clerk. However, this rule does not apply to known mailers who prepare traceable labels like that in FIG. 1. Thus, casual shippers have an incentive to use traceable labels where possible.

To accommodate shippers that want to use traceable labels, the USPS has placed Automated Postal Center (“APC”) kiosks in many Post Offices. An example of one such kiosk is depicted in FIG. 2. These kiosks will vend stamps and also print 4×6″ shipping labels. The USPS designed the APC system to minimize manual data input by the customer, so the customer need only input the ZIP5 of the destination and select the type of Priority Mail service and box weight.

The label will then print with a single line having the city, state and ZIP5 (e.g., Palo Alto, Calif. 94301), but the label will not include the address of the sender, nor will it include a compete delivery name and address. Typing in a complete destination address, not to mention a complete return address, was felt to be too time consuming by the designers.

Because the shipper is required to manually enter (i.e., handwrite) the name and street address of the intended recipient on the label, the USPS does not capture the complete delivery information electronically during use of the APC kiosk. Some indication of the shipper's identity can be obtained by capturing the credit card used for the transaction. However, credit card data only includes the billing ZIP for the customer, not the full address.

It should be noted that during holiday seasons, long lines commonly form at the APCs as people try to ships gifts to their loved ones. Even with the minimal amount of information requested at the APC, the label printing transactions still take significant time.

Some existing systems try to avoid these problems by using a software application that requires an email exchange between the sender and the shipping agent. For instance, FedEx offers a mobile application that, once the sender provides a level of information for a shipping label, will cause FedEx to send (via email) a barcode representative of that shipping information that has been provided. This system requires the sender to first set up an account with FedEx, using an email interface to exchange information with FedEx, and requires the user to bring up and display the barcode to a human representative of FedEx so that the barcode can be scanned by the representative at a FedEx store.

Thus, a need exists for systems, devices, and methods that allow the efficient entry of data to the APC kiosks, other USPS label printing systems, retail counters, or other retail shipping facilities. A need also exists to capture complete electronic shipment data from customers using APC kiosks, other USPS label printing systems, retail counters, or other retail shipping facilities.

### SUMMARY

Provided herein are systems, devices, and methods for a sender to use of a mobile device to interface with a shipping agent's environment for the purpose of generating a shipping label. In one example embodiment, the sender identifies shipping label information (as well as other information about the sending of the mail piece) through a mobile application operating on the sender's mobile device. The mobile application can then facilitate the transfer of the shipping label information to the shipping agent's environment, examples of which include a kiosk (e.g., a USPS APC), a retail counter, or the like. The shipping agent's environment can then produce or print a hardcopy of the shipping label for use on the mail piece (e.g., parcel or package) to be shipped. Use of the mobile device allows the sender to take advantage of a well-practiced interface (e.g., such as a touchscreen display) to efficiently identify the shipping label information. The mobile device also allows easy access to the sender's contacts database, which can eliminate the need to manually enter names and address information on a character-by-character basis. The mobile device and shipping agent's environment can be adapted for the efficient transfer of information therebetween, allowing the sender to quickly obtain one or more shipping labels without the need for separate data entry to the shipping agent's environment. The mobile device can also process payment for the shipment, further minimizing interaction with the shipping agent's environment. This, in turn, can reduce the wait time at the shipping agent's environment, such as long lines that can manifest during the holidays.

In another example embodiment, a method of obtaining a shipping label for a package is provided, the method including identifying shipping label information with a mobile device, transferring data representative of the shipping label information from the mobile device to a publicly accessible self-service kiosk, and obtaining a hardcopy shipping label from the kiosk, wherein the hardcopy shipping label is based on the data representative of the shipping label information transferred from the mobile device.

In another example embodiment, a mobile device is provided including a display, a user interface, and a processor configured to run a mobile application, wherein the processor, when running the application, is configured to accept user input through the user interface that identifies shipping label information relating to the shipment of a mail piece, and display a barcode representative of the shipping label information on the display, the barcode being scannable in a shipping agent's environment.

In another example embodiment, a mobile device is provided including a shipping agent environment interface, a user interface, and a processor configured to run a mobile application, wherein the processor, when running the application, is configured to accept user input through the user interface that identifies shipping label information relating to the shipment of a mail piece, and transfer data representative of the shipping label information to a shipping agent's environment through the shipping agent environment interface.

Other systems, devices, methods, features, and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should any aspect of the example embodiments be construed as limiting the appended claims, absent express recitation of that aspect in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 depicts an example prior art shipping label that is traceable.

FIG. 2 depicts an example USPS Automated Post Center (“APC”).

FIG. 3 is a block diagram depicting an example embodiment of a shipping label information collection system.

FIG. 4 depicts an example embodiment of a top-level, or primary information identification screen on a mobile device.

FIG. 5 depicts an example embodiment of a contact list on the screen of a mobile device.

FIG. 6 depicts an example embodiment of a selected recipient on the screen of a mobile device.

FIG. 7 depicts an example embodiment of the adoption of a selected recipient on the screen of a mobile device.

FIG. 8 depicts an example embodiment of an enhanced recipient address on a screen of a mobile device.

FIG. 9 depicts an example embodiment of a screen on a mobile device which shows a box type selection button.

FIG. 10 depicts an example embodiment of a screen shot of a mobile device screen which presents choices of box types.

FIG. 11 depicts an example embodiment of a screen shot of a mobile device screen which presents choices for the amount for which the package will be insured.

FIG. 12 depicts an example embodiment of a screen shot which presents choices of other services the shipper can elect.

FIG. 13 depicts an example embodiment of a screen on a mobile device which shows selections of email, box type, insurance and service options.

FIG. 14 depicts an example embodiment of a screen showing a bar code having additional data which may be transmitted from a mobile device to a device capable of printing a shipping label.

FIG. 15 is a block diagram depicting another example embodiment of a shipping label information collection system.

### DETAILED DESCRIPTION

It should be noted that all features, devices, systems, elements, components, functions, and steps described with respect to any embodiment of the systems, devices, and methods described herein are intended to be freely combinable and substitutable with those from any other embodiment. If a certain feature, device, system, element, component, function, or step is described with respect to only one embodiment, then it should be understood that that feature, device, system, element, component, function, or step can be used with every other embodiment described herein unless explicitly stated otherwise. This paragraph therefore serves as antecedent basis and written support for the introduction of claims, at any time, that combine features, devices, systems, elements, components, functions, and steps from different embodiments, or that substitute features, devices, systems, elements, components, functions, and steps from one embodiment with those of another, even if this specification does not explicitly state, in a particular instance, that such a combination or substitution is possible.

The systems, devices, and methods described herein could be used with the USPS APC, modified to accept a complete shipping request from a mobile device. Also, the equipment used by a USPS retail clerk (e.g., the USPS POS1 system) could be modified or supplemented in accordance with the disclosure provided herein to receive a complete shipping request from a shipper's mobile device during a face-to-face transaction between the shipper and the clerk. Even further, the equipment or kiosk used by a retail shipping service at a facility such as a UPS Store, FedEx Depot, or Office Depot, could be modified or supplemented in accordance with the disclosure provided herein to receive a complete shipping request from a shipper's mobile device.

The systems, devices, and methods described herein allow users of kiosks (or retail shipping facilities), located at a publicly accessible location (e.g., not in a user's private home), to prepare a complete shipping request on a mobile device before the user arrives at the kiosk or while the user stands in line at the kiosk. When the user reaches the point of the transaction, the shipping label request can be quickly relayed to kiosk, allowing the user to pay, receive the label, and depart in a more expedient fashion.

The systems, devices, and methods are applicable to the postal departments and retail shipping services in all major countries, including, but not limited to the United States, Canada, Mexico, the United Kingdom, France, Germany, Italy, Spain, Russia, Ukraine, Israel, India, China, Korea, and Japan.

In one embodiment, the mobile device includes a payment processing software routine or application and is further configured to provide complete shipping information as well as to collect the necessary payment from the shipper and convey it to the carrier via the kiosk or retail counter. The payment processing routing can request and capture the sender's billing zip code, which could be different from the return zip code and thus would constitute another piece of information that can be used for identification (and security) purposes. The billing zip code can be associated with the shipping label information transferred to the shipping agent's environment.

In another embodiment, the systems, devices, and methods described herein are used to accept information about the identity of the contents of the package. For international transactions, this information is usually presented in the form of a customs manifest.

FIG. 3 is a block diagram depicting an example embodiment of a shipping label information collection system 100. Here, a mobile device 102 is capable of communication with a shipping agent's environment, which in this example is a kiosk 110, and both are capable of internet communication with a server 120. Mobile device 102 can be a phone or smart phone, a laptop, a tablet (such as an iPad), a personal digital assistant, or generally any compact handheld device with internet capability. Mobile device 102 preferably includes one or more of the following: a display 103, a user interface 104 such as a keypad, an operating system (OS) 105, a shipping label information collection software application 106 (also referred to herein as a “mobile application”), a shipping agent environment (e.g., kiosk) interface 107, and a processor and memory 108. User interface 104 can be a physical interface or a virtual interface (e.g., display 103 and user interface 104 can be combined as, e.g., a touchscreen). User interface 14 is configured to receive a user input 101 that identifies desired shipping label information.

The kiosk 110 is preferably placed in a publicly accessible location and is capable of receiving shipping label information from mobile device 102 and using that information to print a shipping label 130. Kiosk 110 can be connected to the internet 121 and can include a display 111, a user interface 112, a mobile device interface 113, a printer 114 for printing the shipping label 130, and a processor and memory 115. Kiosk 110 can also include payment processing equipment (e.g., a credit card reader) for processing the payment for the shipment. Like the case with mobile device 102, display 111 and user interface 112 can be combined as a touchscreen. Kiosk 110 can be configured as a self-service, stand-alone device, similar to an automated teller machine (ATM).

Kiosk 110 can include a camera (not shown) for taking one or a plurality of photographs and/or one or a plurality of videos of the sender during the transaction. This can be, for instance, a color high-definition (HD) camera or HD video camera. This recorded visual media can be stored and associated with the shipping label, and transmitted to and stored at server 120 and/or carrier API 140. This can provide an additional way to identify the shipper and supplement the security level of the shipment stream.

Shipping label information identified with mobile device 102 can be transferred to kiosk 110 (through kiosk interface 107 and mobile device interface 113) over communication link (or path) 122, which will be discussed in more detail later. Link 122 can be either unidirectional (mobile device to kiosk) or bi-directional.

Both mobile device 102 and kiosk 110 are connected to a server 120 through an internet connection 121. Server 120 requests a shipping label from the carrier API and distributes it to the appropriate kiosk 110 for printing. Server 120 also controls pricing for the use of the mobile application 106, coordinates ZIP validation, and provides updated lists of options for carrier-specific sets of information (e.g., services offered, levels of insurance, and package types). Server 120 also acts as a record keeping entity and stores every possible part of the transaction including tracking number, price, recorded visual media of the sender or customer, piece weight, zone, the date and time that the label was created, the delivery and return addresses, any optional services, and all other shipping label information and information related to the shipment discussed herein. A payment transaction token can be stored as well, in case a need for a refund arises. Credit card information can be stored but this is not preferred. The payment transaction token is used as a reference with a third party payment gateway (e.g., PayPal and the like) that may store the credit card information.

In one embodiment, operating system 105 is a smart phone OS such as that provided for the iPhone, Android, or BlackBerry. OS 105 has an interface that allows access to contact information, including physical addresses, phone numbers, and email addresses. Mobile application 106 is adapted to operate with a typical smart phone. A user is able to download the mobile application 106 from an approved on-line store (e.g., iTunes store for the iPhone or iPad OS, Google Play store for the Android OS), the mobile application developer's website, or an approved or licensed third party website.

The mobile application 106 provides an interface through which the user can identify the information for the shipping label 130, as well as other information related to the sending of the package. FIG. 4 is an example screen display (e.g., a screen shot) 201 of a top level (or primary) information entry point, showing multiple sets of shipping related information that the user can select, and for each the user can identify the appropriate information or option. This is a screen shot taken from an embodiment utilizing an Apple iPhone. Naturally, the look and feel of the application can vary widely and the screen shots shown are but one example of many different configurations.

In this embodiment, an interface 202 is labeled “To” and corresponds to a first set of information, namely the identity of the intended recipient and destination of the package. A second interface 203 is labeled “From” and pertains to the identity of the shipper or sender and the return address. A third interface 204 is labeled “Email” and pertains to the email address or addresses where tracking information about the shipment of the package will be sent. A fourth interface 205 is labeled “Box Type” and pertains to the type of package or box being used for the shipment. A fifth interface 206 is labeled “Insurance” and pertains to the amount of insurance obtained for the package, and a sixth interface 207 is labeled “Services” and pertains to special services that may be selected, such as delivery confirmation, signature confirmation, hold for pickup, adult signature required, certified mail, registered mail, and other services known to those of ordinary skill in the art. In this embodiment each interface 202-207 is a touchscreen button, but those of ordinary skill in the art will recognize that any type of interface can be used. It should be noted that this embodiment can vary with the needs of the user or environment, and thus not all of these different sets of information are required, and more than those sets shown here can be included, such as an interface to select or identify the carrier, an interface to identify the class of mail (e.g., Express, Priority, First-Class, etc.), and/or an interface to select or identify the package contents.

The selection of each individual interface 202-207 can be followed by a prompt for the user to select an option from a list of options stored permanently in memory (or retrieved via the internet and stored at least temporarily in memory), or by a prompt for the user to manually enter the requisite information (such as with a virtual keyboard common on smart phones and tablets).

FIG. 5 is an example screen display 210 of the user's contact database that is shown after a user has selected interface 202. Mobile application 106 is adapted to interface with the contacts database stored on mobile device 102, and selection of interface 202 causes mobile application 106 to request OS 105 to display the contacts database. The user is then able to navigate (or scroll) the database and select the name of the intended recipient of the package. The corresponding address information of this selection is then displayed, as example screen display 220 in FIG. 6, and the user can then be prompted to confirm the selection with a confirmation interface 221, at which point the address information can be designated as the destination street address, destination city, destination state, and destination zip code (e.g., 5 digit or 9 digit) for the shipping label, or any other combination of destination address information is considered to be the minimal “complete” set of information required for shipping by the carrier.

In one embodiment, the minimal delivery information required from a sender or customer to ship a mail piece is the name of the recipient, the delivery street address, and the delivery city and state. From this information, the five or five+four digit zip codes can be determined and populated automatically by the system. In another embodiment, the minimal delivery information is the name of the recipient, the destination street address, and the five digit zip code. The system can then validate the zip code and populate the destination city, destination state, and addition +4 digits of the zip code automatically. In either embodiment, the population of the missing information can be done on mobile device 102 prior to transfer, or by the agent's shipping environment after transfer from mobile device 102.

Prior to designating the contact information as the destination name and address, mobile application 106 can review the contact information to verify that the information is complete, or at least prompt the user to verify that the information is complete. If the contact entry is only partially completed, then the user can manually enter the requisite information to complete the destination address.

After identifying the destination address, mobile application 106 can perform the address verification and ZIP+4 validation process (typically referred together as “validating” or “validation”). In one example embodiment, selecting the destination address from a contact list results in display of the primary information screen 201 with the selected destination address information, as shown in the example embodiment of FIG. 7. A ZIP+4 validation interface 222 is displayed adjacent the destination address. Actuating (or pressing) this button initiates the ZIP+4 validation, which verifies the destination address and adds the ZIP+4, as shown in the updated example screen shot 201 of FIG. 8 (note the addition of the 4 numerals to the 5-digit ZIP code). The address verification process is accomplished through server 130 using a web service that links to the USPS national address database. U.S. Pat. No. 5,341,505 describes an example of this process and is incorporated by reference herein in its entirety. If the address is unknown or noted by the USPS as undeliverable, then a warning is generated and a corresponding warning message is displayed on mobile device 102. The user is prompted to correct the address, but may proceed to transfer the information and generate the shipping label with an unvalidated address if desired.

Selecting interface 203 (the “From” button) once again calls up the user's contact list. The information corresponding to the sender and the return address can be identified, verified, and validated in the same manner as described above with respect to the intended recipient and destination address (see FIGS. 4-8). FIG. 9 depicts an example screen shot 201 with the identified recipient/destination and sender/return information.

Interface 204 operates to allow the user to select the one or more email addresses where tracking information will be sent by the carrier. Actuation of interface 204 can bring up a contacts list in a manner similar to that described above to allow the user to select the one or more contacts with the appropriate email address. Alternatively, the user can input the email address manually through user interface 104 on a character-by-character basis.

Interface 205 allows the user to select the package type. Actuation of this interface 205 can call up a list of preset options as to various standard package or box types. In the example screen shot 230 of FIG. 10, a list of package options are displayed with the assumption that the carrier is the USPS and the class of mail is Priority. As mentioned, separate interfaces (e.g., on screen 201) can be included to identify the carrier and class of mail. Examples of mail classes for the USPS include Priority, Express, First Class Parcel, Parcel Post, etc. Examples of mail classes for UPS include Overnight, Two Day, or UPS Ground Service. Other carriers have similar graduated service classes. Many carriers offer flat rate packaging which means the rate is independent of distance or weight. Any and all service classes and packaging types which might be offered by the carrier can be presented as an option for selection by the user. Upon selection of the desired option, the user can return to the primary screen 201 using the back button.

Interface 206 allows the user to select the amount of insurance for the package and actuation of that interface can switch the display to a list of options for insurance amounts such as that shown in the example screen shot 240 of FIG. 11. Alternatively, user interface 104 can be used to manually enter the insurance amount on a character-by-character basis.

Interface 207 allows the user to select a special service from among those services provided by a particular carrier. Actuation of interface 207 switches the display to a list of options for additional services, such as the example screen display 250 depicted in FIG. 12, where the user can select no services or one or more optional services for the package shipment. Examples of such services include delivery confirmation, signature confirmation, certified return receipt, etc.

It should be noted that each interface 202-207 can be actuated in any order, although in some embodiments it is preferable to identify the carrier prior to identifying the package type, insurance options, special services, or any other set of information that is carrier dependent.

FIG. 13 depicts an example of primary screen 201 after the selection or identification of the desired information for each information set through interfaces 202-207. Once the desired amount of shipping label information has been identified, the user can initiate the date transfer process with actuator 208, which, in this embodiment, will initiate the generation of a barcode (discussed below).

Mobile device 102 can transfer (or present for transferring) that information, or data representative of that shipping label information, to kiosk 110 over communication link 122. Kiosk 110 then transfers the information to server 120 over the internet connection 121. Server 120 then communicates with the selected carrier's API and retrieves an image of the shipping label, which is then communicated back to kiosk 110. Kiosk 110 then preferably prints a hardcopy of the shipping label 130 using printer 114.

Referring back to the transfer of the shipping label information to the kiosk 110, this can be accomplished in a number of ways. In one example embodiment, mobile device 102 uses the shipping label information to natively generate a corresponding barcode (e.g., a one-dimensional (1D) or two-dimensional (2D) barcode) and then displays it on display 103. The barcode is thus generated directly on the mobile device without any email (or similar) communicative exchange with another party. An example embodiment of a 2D barcode on a mobile device screen is depicted in FIG. 14. The user can scan this 2D barcode using a scanner (mobile device interface 113) on kiosk 110. The scanner 113 collects the shipping label information and relays it to the kiosk 110, which processes the information into a format suitable for transfer to server 120. In this embodiment, the kiosk interface 107 of FIG. 3 is omitted and display 103 functions as the kiosk interface 107. In this embodiment, communication link 122 is formed by the optical scanning of the barcode.

In another example embodiment, communication link 122 is an infrared link, such as one operating in accordance with a Bluetooth protocol. The shipping label information can be communicated to kiosk 110 using infrared light. As is known in the art, Bluetooth is a proprietary open wireless technology standard for exchanging data over short distances (using short wavelength radio transmissions) from fixed and mobile devices, creating personal area networks (PANs) with high levels of security. In this embodiment, mobile device interface 113 (on kiosk 110) is a Bluetooth master device and kiosk interface 107 (on mobile device 102) is a Bluetooth slave device. Here, link 122 can be unidirectional or bidirectional.

In yet another example embodiment, transfer of the shipping label information from mobile device 102 to kiosk 110 is performed using Near Field Communication, or NFC. NFC is a set of short-range wireless technologies, typically requiring a distance of 4 cm or less. NFC operates at 13.56 MHz and at rates ranging from 106 kbit/s to 848 kbit/s. The formation of NFC links is known to those of ordinary skill in the art. In this example, both kiosk interface 107 (on mobile device 102) and mobile device interface 113 (on kiosk 110) are preferably powered (as opposed to passive) NFC devices.

Another example embodiment involves the transmission of the shipping label information from mobile device 102 to kiosk 110 via a web service managed by either the shipping agent or a third party. For instance, the data could be configured in an XML format and transmitted to a web server using the Simple Object Access Protocol (SOAP). The process would assign a unique identifier to the captured data, and this unique ID could be used by the shipping agent to access the data.

In still another example embodiment, the shipping label information is transferred to the kiosk 110 via an email service to a central site wherein the shipping label information would be automatically extracted and referenced with the mail to the sender. The shipping agent could then access this information by using the email address of the shipping customer as the search parameter. This approach is less definitive than a unique ID assigned by a Web Service.

While many embodiments have been described with respect to kiosk 110, it should be noted that all embodiments of the systems, devices, and methods described herein can also be used with other embodiments of a shipping agent's environment, such as a retail counter. FIG. 15 is a block diagram depicting an embodiment of system 100 where mobile device 102 interfaces with a retail counter 150 instead of kiosk 110. In this embodiment, retail counter 150 includes a computer 151, a mobile device interface 152, and a printer 153, both of which are communicatively coupled with computer 151. Mobile device interface 152 operates in the same fashion as described above with respect to interface 113 and can receive the aforementioned information about the shipping label and shipment in all manners previously discussed with respect to communication link 122. Likewise, the shipping agent environment interface 123 (e.g., retail counter interface in mobile device 102) can operate in the same fashion as described above with respect to kiosk interface 107.

An agent of the shipper provides input 154 to computer 151 to manage the process of accepting the shipping label information from the sender's mobile device 102 and obtaining a shipping label image from the carrier API by way of the internet connections between computer 150 and server 120 (as well as any internet connection between server 120 and carrier API 140). Retail counter 150 may also include equipment (such as a card swipe) for collecting payment information for the shipping transaction. Printer 153 is used to print shipping label 130.

The shipping agent can be any retailer large or small, including super markets such as Safeway, airports, transit authorities, and the like. A kiosk can be placed in essentially any environment where an internet connection is available, either wireline or wireless. Shopping malls, tourist areas, hotels, restaurants, and the like can all have a kiosk associated with it. An automated locker system can be added to receive the package so that the user does not have to drop it off at a separate location. Completion of the transaction at the kiosk will cause a door to open, drop off your package, and a backend of the system will call or message the carrier for pickup.

It should be noted that the systems, devices, and methods described herein do not require the user or sender to conduct an email exchange with a carrier or third party in order to transfer shipping label information, which is an added level of complexity to the transaction and risks inadvertent loss of the email. Indeed, the user or sender need not even have an email account. Furthermore, because the mobile application can interface directly with a fully automated kiosk, there is no requirement for a staffed transaction (e.g., the user does not have to interface with a representative of the carrier). Nor is there any requirement to maintain an account with a vendor, the mobile application can be downloaded and used to transfer shipping label information directly to the shipping agent's environment without a pre-existing account (payment can be made directly at the kiosk or retail counter). If a user or sender does have an account with the mobile application vendor, then the user can save payment information to the account and more efficiently enact shipping transactions. For instance, the user can select one of any number of shipping transactions stored on the account, and then pay for them all at the end of the transaction, akin to a shopping cart environment found on retail websites like Amazon.com.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A method of obtaining a shipping label for a package, comprising:
identifying shipping label information with a mobile device;
transferring data representative of the shipping label information from the mobile device to a publicly accessible self-service kiosk; and
obtaining a hardcopy shipping label from the kiosk, wherein the hardcopy shipping label is based on the data representative of the shipping label information transferred from the mobile device.

2. The method of claim 1, wherein the shipping label information comprises one or more of the following items: intended recipient's name, destination street address, destination city, destination state, destination country, destination ZIP5, name of return party, return street address, return city, return state, return country, return ZIP5, class of service, package insurance value, email address for tracking notification, phone number for sender, phone number for recipient, and package type.

3. The method of claim 1, wherein the shipping label information comprises all of the following: intended recipient's name, destination street address, destination city, destination state, and destination ZIP5.

4. The method of claim 1, wherein the shipping label information comprises all of the following: name of return party, return street address, return city, return state, and return ZIP5.

5. The method of claim 1, wherein the shipping label information comprises all of the following: intended recipient's name, destination street address, destination city, destination state, destination ZIP5, name of return party, return street address, return city, return state, and return ZIP5.

6. The method of claim 1, further comprising transferring a device ID of the mobile device and a user name of the mobile device to the kiosk.

7. The method of claim 1, further comprising displaying a 2-dimension barcode representative of the shipping label information, wherein transferring data representative of the shipping label information comprises scanning the 2-dimensional barcode at the kiosk.

8. The method of claim 1, wherein the transfer of data representative of the shipping label information to the kiosk is performed over an infrared communication link.

9. The method of claim 1, wherein the transfer of data representative of the shipping label information to the kiosk is performed over a near-field communication link.

10. The method of claim 1, wherein the transfer of data representative of the shipping label information to the kiosk is performed over the internet.

11. The method of claim 1, wherein the shipping label information comprises a delivery address, the method further comprising validating the delivery address with a web service transaction.

12. The method of claim 11, wherein validating the delivery address with a web service transaction comprises referencing the USPS national address database.

13. The method of claim 11, wherein validating the delivery address comprising appending a +4 character string to a ZIP5 character string.

14. The method of claim 1, further comprising:
identifying package contents and customs declaration data with the mobile device; and
transferring data representative of the package contents and customs declaration data to the kiosk.

15. The method of claim 1, further comprising transferring payment information to pay for the shipping label to the kiosk.

16. The method of claim 1, wherein identifying shipping label information with a mobile device comprises identifying a contact as an intended recipient from a list of contacts displayed on the mobile device.

17. The method of claim 16, further comprising extracting the destination street address, destination city, destination state, and destination ZIP5 from the identified contact, wherein the shipping label information comprises the extracted information.

18. The method of claim 1, wherein identifying shipping label information with a mobile device comprises identifying an option from a stored set of options corresponding to one or more of the following: a set of delivery address options, a set of return address options, a set of mail class options, a set of package type options, a set of special services options, and a set of insurance options.

19. A mobile device, comprising:
a display;
a user interface; and
a processor configured to run a mobile application, wherein the processor, when running the application, is configured to accept user input through the user interface that identifies shipping label information relating to the shipment of a mail piece, and display a barcode representative of the shipping label information on the display, the barcode being scannable in a shipping agent's environment.

20. The mobile device of claim 19, wherein the display and user interface are combined as a touchscreen.

21. The mobile device of claim 19, wherein the shipping agent's environment is a kiosk or a retail counter.

22. The mobile device of claim 19, wherein the barcode is a two-dimensional barcode.

23. The mobile device of claim 19, wherein the processor, when running the mobile application, is configured to interface with a database of user contacts stored in a memory of the mobile device and accept a user selection of a contact from the database as an identification of a destination address for the mail piece.

24. The mobile device of claim 19, wherein the shipping label information comprises one or more of the following: intended recipient's name, destination street address, destination city, destination state, destination country, destination ZIP5, name of return party, return street address, return city, return state, return country, return ZIP5, class of service, package insurance value, email address for tracking notification, phone number for sender, phone number for recipient, and package type.

25. The mobile device of claim 19, wherein the shipping label information comprises the minimum amount of information required by a shipping label to ship the mail piece.

26. A mobile device, comprising:
a shipping agent environment interface;
a user interface; and
a processor configured to run a mobile application, wherein the processor, when running the application, is configured to accept user input through the user interface that identifies shipping label information relating to the shipment of a mail piece, and transfer data representative of the shipping label information to a shipping agent's environment through the shipping agent environment interface.

27. The mobile device of claim 26, wherein the shipping agent's environment is a kiosk or a retail counter.

28. The mobile device of claim 26, wherein the shipping agent environment interface is either an infrared communication interface or a near field communication (NFC) interface.

29. The mobile device of claim 26, wherein the processor, when running the mobile application, is configured to interface with a database of user contacts stored in a memory of the mobile device and accept a user selection of a contact from the database as an identification of a destination address for the mail piece.

30. The mobile device of claim 26, wherein the shipping label information comprises one or more of the following: intended recipient's name, destination street address, destination city, destination state, destination country, destination ZIP5, name of return party, return street address, return city, return state, return country, return ZIP5, class of service, package insurance value, email address for tracking notification, phone number for sender, phone number for recipient, and package type.

31. The mobile device of claim 26, wherein the shipping label information comprises the minimum amount of information required by a shipping label to ship the mail piece.
